(19) United States
(12) Patent Application Publication
(10) Pub. No.: US 2016/0039250 A1
(43) Pub. Date: Feb. 11, 2016

(54) TIRE TREAD DEPTH INDICATOR

(71) Applicant: Caterpillar Inc., Peoria, IL (US)

(72) Inventors: David Colantoni, Metamora, IL (US); Adam Ofisher, Elk Grove, IL (US); Trent J. Cleveland, Metamora, IL (US)

(73) Assignee: Caterpillar Inc., Peoria, IL (US)

(21) Appl. No.: 14/920,886

(22) Filed: Oct. 23, 2015

(51) Int. Cl. B60C 11/24

(52) U.S. Cl. CPC B60C 11/24

(57) ABSTRACT

A tire is provided. The tire includes a body. The body includes a first surface for supporting a plurality of treads. The plurality of treads extends at a pre-defined depth from the first surface to a second surface configured for ground contact. The treads include a third surface extending between the first surface and the second surface. The tire further includes a tread depth indicator molded on the third surface. The tread depth indicator includes a plurality of spaced tread depth markings provided on the third surface. Further, each of the plurality of tread depth markings are spaced apart at a predetermined distance from an adjacent tread depth marking. The plurality of tread depth markings indicates a progressive wear and reduction of the pre-defined depth of the plurality of treads relative to the second surface.

### TECHNICAL FIELD

The present disclosure relates to a tire, and more particularly to a tire having a built-in tread depth indicator.

### BACKGROUND

Machines, such as off-highway trucks, are used to perform various operations in different industries, such as construction, mining, and transportation. Operation of the machines may result in wear of various components of the machines, such as tires. More particularly, a tread of the tires are prone to wear over a period of time. The treads are periodically inspected to identify whether the tires require repair or replacement. Conventional methods for identifying wear of the treads require special depth measurement tools, such as a tread depth gauge. The identification methods also require skilled labor for accurate identification of the wear of the treads.

U.S. Pat. No. 8,403,012, hereinafter referred to as the '012 patent, describes a tread wear indicator for a tire. The tread wear indicator is molded into the shoulder region of a tire tread and has three symbols. Two of the symbols of the tread wear indicator are alphanumeric characters and the third symbol is surrounding the two symbols. All three symbols are visible prior to wearing the tread. After the tread has been worn a first amount, the first symbol is invisible and the second and third symbols are visible to indicate the wear. After the tread has been worn a second amount, the first and second symbols are invisible and the third symbol is visible. However, the '012 patent does not provide a progressive wear indication of the treads of the tire.

### SUMMARY OF THE DISCLOSURE

In one aspect of the present disclosure, a tire is provided. The tire includes a body. The body includes a first surface for supporting a plurality of treads. The plurality of treads extends at a pre-defined depth from the first surface to a second surface configured for ground contact. The treads include a third surface extending between the first surface and the second surface. The tire further includes a tread depth indicator molded on the third surface. The tread depth indicator includes a plurality of spaced tread depth markings provided on the third surface. Further, each of the plurality of tread depth markings are spaced apart at a predetermined distance from an adjacent tread depth marking. The plurality of tread depth markings indicates a progressive wear and reduction of the pre-defined depth of the plurality of treads relative to the second surface.

Other features and aspects of this disclosure will be apparent from the following description and the accompanying drawings.

### BRIEF DESCRIPTION O F THE DRAWINGS

FIG. 1 is a perspective view of an exemplary machine having one or more tires, according to the concepts of the present disclosure;

FIG. 2 is a perspective view of the tire having treads, according to the concepts of the present disclosure; and

FIG. 3 is a partial perspective view of the treads shown in FIG. 2.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

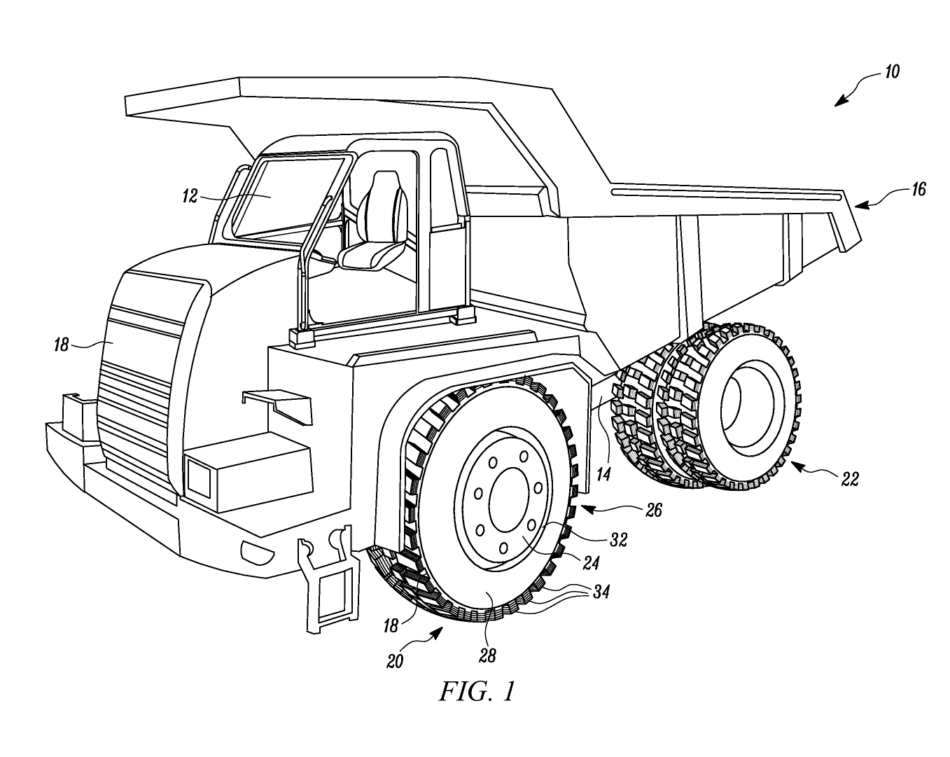

FIG. 1 illustrates an exemplary machine 10. The machine 10 may perform different tasks on a worksite. For example the machine 10 may be used to transport material from one location to another on the worksite. The machine 10 may include, but not limited to, a mining truck, a haul truck, an on-highway truck, an off-highway truck or an articulated truck. Alternatively, the machine 10 may embody a loading machine that unloads load onto another machine. In such an example, the machine 10 may include, but not limited to, a large wheel loader, a track-type loader, a shovel or a crane.

As shown in FIG. 1, the machine 10 is an off-highway truck. However, the concepts of the present disclosure may be embodied in a different type of machine. The machine 10 includes a frame 14. An operator cabin 12 is mounted on the frame 14 of the machine 10. The machine 10 also includes a load carrier 16 for carrying payload. Further, an engine cabin 18 may be mounted on the frame 14. A power source (not shown) is positioned within the engine cabin 18. The power source can be an engine that generates power to propel the machine 10. The machine 10 also includes a powertrain (not shown) supported on the frame 14. The power train is drivably connected to the power source.

The machine 10 also includes a number of wheels of which two wheels 20, 22 are shown in the accompanying figures. Each wheel of the machine 10 is rotatably coupled with the powertrain. It should be noted that the number of wheels shown in the accompanying figures are exemplary in nature, and the number of wheels may vary based on type of operation performed by the machine 10. For exemplary purposes, the present disclosure will be described with respect to the wheel 20. However, it should be noted that the description provided is equally applicable to each wheel of the machine 10.

The wheel 20 includes a hub 24 connected to the powertrain. The wheel 20 further includes a tire 26 connected to the hub 24. The tire 26 as shown in FIG. 1 are ground engaging members of the machine 10. The tire 26 may provide a desired amount of traction and cushioning between the machine 10 and a ground surface on the worksite. For example, the tire 26 may support the machine 10 in a loaded, partially loaded, and empty condition, so that a desired amount of traction and/or cushioning is provided, regardless of the load. The tire 26 may be manufactured by any suitable manufacturing method known in the art. The tire 26 can be bias, radial or bias-belted, steel belted.

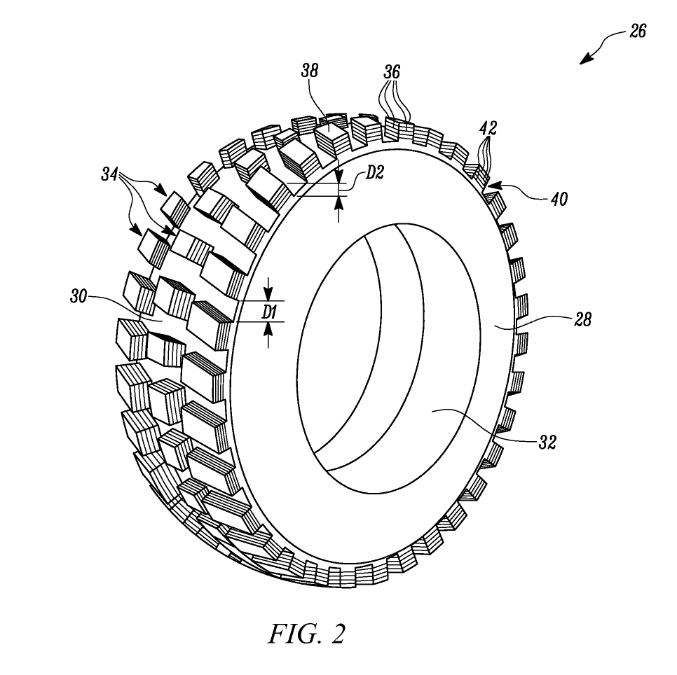

Referring to FIGS. 1 and 2, the tire 26 includes a body 28. The tire 26 also includes a first surface 30, hereinafter interchangeably referred to as outer surface 30, and an inner surface 32. Further, the inner surface 32 of the tire 26 is coupled with the hub 24.

As shown in FIGS. 1 and 2, the tire 26 includes a number of treads 34. The treads 34 are supported on the outer surface 30 of the body 28. The treads 34 improves traction of the tire 26 at the interface between the tire 26 and the ground surface across which the tire 26 rolls. The treads 34 are embodied as protrusions extending radially from the outer surface 30 of the tire 26. In one embodiment, the body 28 and the treads 34 are integrally formed as a single, monolithic piece, for example, via molding. In another embodiment the treads 34 are formed separately, and are later assembled with the body 28 to form a single, monolithic piece. In yet another embodiment, the treads 34 and the body 28 may be chemically bonded to one another.

Referring to FIG. 2, a perspective view of the tire 26 having the number of treads 34 is illustrated. Each of the treads 34 are spaced apart from each other by a pre-defined distance “D1”. The pre-defined distance “D1” between the treads 34 may allow evacuation of water, mud, and the like from the tire 26. The pre-defined distance “D1” may vary on expected use of the tire 26. For example, the tire 26 used in high performance machines may have a reduced distance “D1” between the treads 34 to provide increased contact of the treads 34 with the ground surface for higher traction. Further, the tire 26 of machines used for off tract or worksite applications may have an increased distance “D1” between the treads 34 to provide higher gripping performance.

The treads 34 may be disposed on the outer surface 30 of the tire 26 in a pre-defined tread pattern. In one example, the pre-defined distance “D1” between the treads 34 is defined based on the pre-defined tread pattern. The pre-defined pattern includes, but not limited to, rib, lug, rib-lug, block, or a combination of patterns known in the industry. The pre-defined tread pattern is determined based on the expected use of the machine 10 in which the tire 26 is implemented. In one example, for paved road and high speed applications, rib type treads may be used to provide low rolling resistance, reduced heat generation, high resistance to side slippage, improved steering and safety, and reduced vibration. In another example, block type of treads may be implemented mainly in off road and worksite applications such as loading or sand service vehicles. The block type treads may provide improved propulsion, braking, steering, and safety.

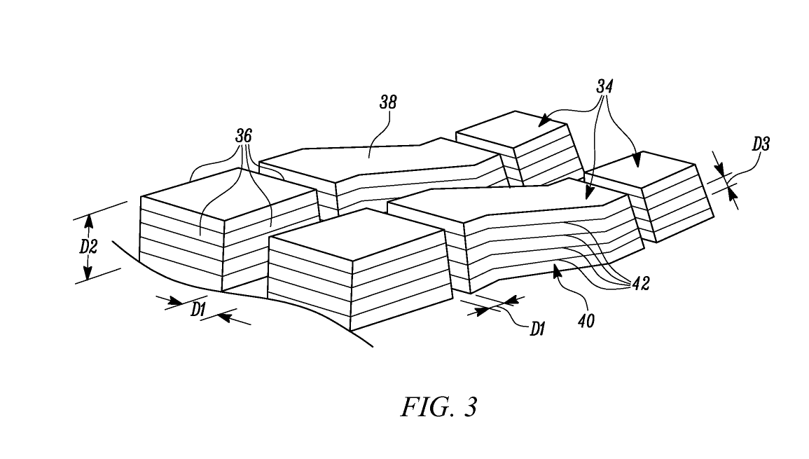

As shown in the FIGS. 2 and 3, the treads 34 include a second surface 38, such that the treads 34 extend at a pre-defined depth “D2” from the outer surface 30 of the body 28 to the second surface 38. The second surface 38 of the treads 34 contacts the ground surface. The treads 34 also include a third surface 36, hereinafter interchangeably referred to as a lateral surface 36. The lateral surfaces 36 extend radially with respect to the outer surface 30 of the tire 26. The lateral surfaces 36 extend between the outer surface 30 of the body 28 and the second surface 38 of the treads 34. Further, the second surface 38 connects the pair of lateral surfaces 36 close to a top end of the respective tread 34. The treads 34 also include a bottom surface (not shown). The bottom surface of the treads 34 is attached to the outer surface 30 of the tire 26.

The treads 34 includes a pre-defined depth “D2” defined between the second surface 38 and the bottom surface of the treads 34. The pre-defined depth “D2” of the treads 34 is determined based on the expected use of the tire 26. In one example, the pre-defined depth “D2” may be approximately between 90 mm to 100 mm. In another example, the pre-defined depth “D2” may be approximately between 60 mm to 70 mm.

The tire 26 experiences significant wear during operation of the machine 10. Thus, the pre-defined distance “D1” of the treads 34 reduces gradually after the machine 10 is put in operation. During a maintenance schedule of the machine 10, a maintenance personnel may determine a current depth of the treads 34 so that the tire 26 may be repaired or replaced accordingly. The term “current depth” referred to herein may be defined as the depth of the treads 34 after the machine 10 is put in operation. The current depth of the tread 34 is generally less than the pre-defined depth “D2”.

In order to determine the current depth of the treads 34, a tread depth indicator 40 is molded on the lateral surface 36 of the treads 34. Referring to FIGS. 2 and 3, the tread depth indicator 40 includes a number of spaced tread depth markings 42. In one example, the tread depth markings 42 indicate a progressive wear of the treads 34 and a reduction of the pre-defined depth “D2” of the treads 34 with respect to the second surface 38 of the treads 34. The tread depth markings 42 are disposed on the lateral surfaces 36 of the treads 34. Each of the tread depth markings 42 are spaced apart at a predetermined distances “D3” (see FIG. 3) from an adjacent tread depth marking 42.

The distance “D3” between each tread depth marking 42 is appropriately chosen based on the pre-defined depth “D2” of the treads 34. More particularly, if the distance “D3” between the adjacent tread depth markings 42 is less than a pre-defined distance, a visual identification of a count of the tread depth markings 42 may be difficult. Similarly, if the distance “D3” between the adjacent tread depth markings 42 is more than the pre-defined distance, the wear of the treads 34 may not be recorded and/or noticed accurately. The pre-defined distance disclosed herein may be defined based on an expected application of the machine 10 and/or the pre-defined depth “D2” of the treads 34. For instance, if the pre-defined depth “D2” of the treads 34 is approximately equal to 90 mm, the pre-defined distance between the adjacent tread depth markings 42 may be approximately between 3 mm to 5 mm.

As shown in FIG. 3, the tread depth markings 42 are provided on the lateral surfaces 36 of the treads 34. The tread depth markings 42 are embodied as linear graduations on the lateral surfaces 36 of the treads 34. The tread depth markings 42 may be formed on the lateral surfaces 36 during manufacturing of the treads 34. In one example, the tread depth markings 42 may be formed during molding of the treads 34. For example, a mold pattern of the treads 34 may include a number of spaced apart projections provided on its inner surface. After molding of the treads 34, the projections may form grooves on the treads 34 indicative of the tread depth markings 42. The tread depth markings 42 may have a U-shaped groove, a V-shaped groove, etc., without any limitations. In another embodiment, the tread depth markings 42 may be formed by engraving the lateral surfaces 36 of the treads 34 in a preferred shape. The tread depth markings 42 may include symbols indicating the number of tread depth markings 42. The symbols may be alphabets, alphanumeric, and/or numerals. In one example, the treads 34 may be painted to form the tread depth markings 42.

As indicated in FIG. 3, the tread depth markings 42 defined at the lateral surface 36 of the treads 34 are visible prior to wearing of the treads 34. During an operation of the machine 10, the second surface 38 of the treads 34 interacts with the ground surface. Over a period of time, the treads 34 are subjected to wear due to constant contact between the treads 34 and the ground surface. As the treads 34 wear, a count of the tread depth markings 42 decreases. A product of the count of the tread depth markings 42 and the distance “D3” between the adjacent tread depth markings 42 gives an indication of the current depth of the treads 34.

The tread depth indicators 40 disclosed herein may be provided on the lateral surface 36 of the treads 34 by other methods known in the art such as, for example, by permanent marking, laser engraving, embossing, or etching, without limiting the scope of the present disclosure.

### INDUSTRIAL APPLICABILITY

The present disclosure relates to the tires 26 of the machine 10. The tires 26 incudes the tread depth indicator 40 defined on the treads 34. The tread depth indicator 40 includes the number tread depth markings 42. Since the tread depth markings 42 are provided on the lateral surfaces 36 of the treads 34 during manufacture thereof, any additional components or system are not required for tread depth measurements or wear monitoring of the treads 34. Each of the tread depth markings 42 is indicative of the progressive wear of the treads 34 with respect to the second surface 38. Based on the determination of the current depth of the treads 34, the maintenance personnel is notified whether the treads 34 require repair and/or replacement. Further, the tread depth markings 42 may provide an indication if the tires 26 require immediate attention. Thus, any possible failures of the machine components may be prevented, thereby reducing machine 10 downtime.

Additionally, the tread depth markings 42 provided on the treads 34 enables identification of several types of abnormal tread wear. For example, the innermost or outermost treads 34 of the tire 26 may be subjected to wear due to poor wheel alignments. Also, unbalanced wheels can cause uneven wear of the treads 34 due to abnormal wheel rotation. Further, defects in respect of a suspension system of the machine 10 can also be identified based on the worn condition of the treads 34.

The tread depth indicator 40 disclosed herein provides a cost effective and easy to implement solution for tread depth measurement and also provides simplified wear indication. Further, in some situations, the tread depth indicator 40 allows determination of the current depth of the treads 34 by visually inspecting the treads 34, thereby eliminating requirement of costly and time consuming indication apparatus.

While aspects of the present disclosure have been particularly shown and described with reference to the embodiments above, it will be understood by one skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A tire comprising:
a body having a first surface for supporting a plurality of treads, the plurality of treads extending at a pre-defined depth from the first surface to a second surface configured for ground contact, and a third surface extending between the first surface and the second surface; and
a tread depth indicator molded on the third surface, the tread depth indicator including:
a plurality of spaced tread depth markings provided on the third surface, each of the plurality of tread depth markings are spaced apart at a predetermined distance from an adjacent tread depth marking, the plurality of tread depth markings being indicative of a progressive wear and reduction of the pre-defined depth of the plurality of treads relative to the second surface.
